(19) United States
(12) Patent Application Publication
(10) Pub. No.: US 2005/0057938 A1
(43) Pub. Date: Mar. 17, 2005

(54) Motor vehicle light

(75) Inventors: Jens Mertens, Esslingen (DE); Frank Maschkiwitz, Ebersbach (DE); Andreas Erber, Ostfildern (DE)

Correspondence Address: WARN, HOFFMANN, MILLER & LALONE, .P.C, PO BOX 70098, ROCHESTER HILLS, MI, 48307, US

(73) Assignee: Schefenacker Vision Systems Germany GmbH & Co. KG, Esslingen (DE)

(21) Appl. No.: 10/893,191

(22) Filed: Jul. 16, 2004

(30) Foreign Application Priority Data
Jul. 17, 2003 (DE) DE 103 32 393.7

(51) Int. Cl. F21V 7/04

(52) U.S. Cl. 362/487

(57) ABSTRACT

A light for a vehicle. The light includes at least one light source which is permanently connected to a light guide material.

### CROSS-REFERENCE TO RELATED APPLICATIONS

This application claims priority to German Patent Application No. DE 103 32 393.7 filed on Jul. 17, 2003.

### BACKGROUND OF THE INVENTION

The invention relates to a light for vehicles, in particular motor vehicles. There are known lights in which several light sources and a light guide are produced and installed separately from each other. This production and installation is accordingly costly. The object of the invention is so to develop a light that it can be produced and/or installed simply. This object is accomplished in the light, according to the present invention.

### SUMMARY OF THE INVENTION

Since, in the light according to the invention, the light guide and the light source are permanently connected to each other, the light is simple to produce and install. The light may be provided at any suitable location in the vehicle, for example in the outside rear-view mirror of a motor vehicle, as a repeat blinker.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a side view, in simplified representation, of a part of a light according to the invention;

FIG. 2 in enlarged representation, shows various angles of incidence of light from a source connected to a light guide in the light according to FIG. 1;

FIG. 3 shows a portion of a second embodiment of a light according to the invention in perspective representation;

FIG. 4 shows a bottom view in the direction of the arrow IV in FIG. 3;

FIG. 5 shows a third embodiment of a light according to the invention in top view;

FIG. 6 shows a section of the line VI-VI in FIG. 5; and

FIG. 7 shows a portion of the light according to FIGS. 5 and 6 in side view and in enlarged representation, with various angles of incidence of the light from the source into the light guide.

### DETAILED DESCRIPTION OF THE PREFERRED EMBODIMENTS

The following description of the preferred embodiment(s) is merely exemplary in nature and is in no way intended to limit the invention, its application, or uses.

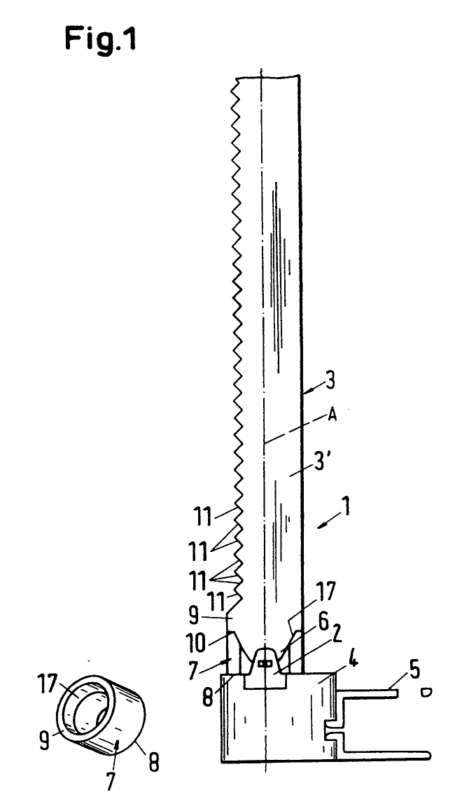

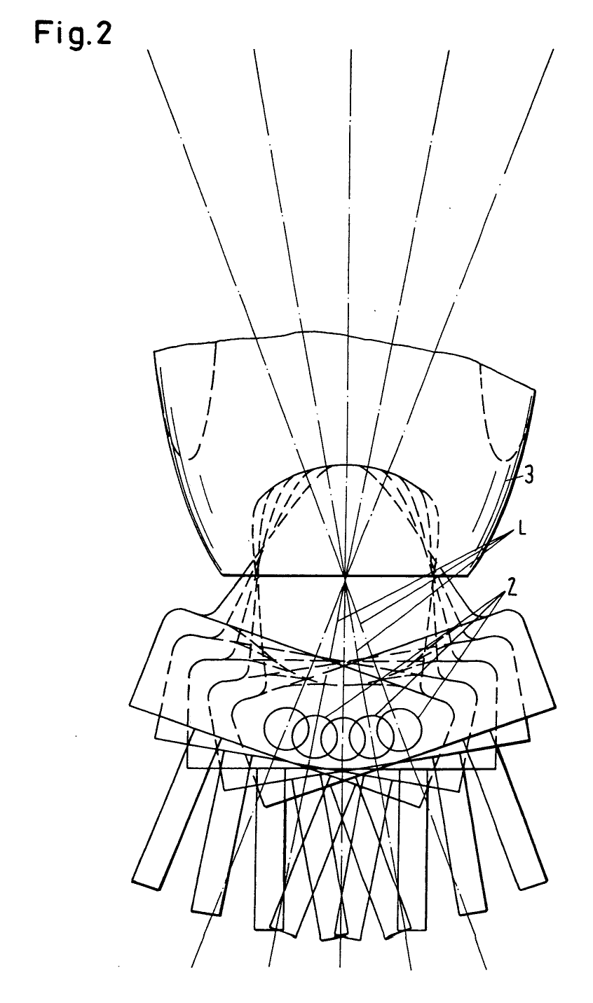

The light 1 represented in FIGS. 1 and 2 is of rod-like configuration and intended for motor vehicles. It consists essentially of a rod-shaped light guide 3 permanently connected preferably at both ends (in the drawing, only one end is represented) to a light source 2 in each instance.

The light guide 3 is made in known manner of suitable synthetic material. The light sources 2 are permanently connected to the light guide by injection, casting or bonding roundabout. The light guide 3, in this embodiment by way of example, has tapered ends 6, into which the light source 2 projects. The tapered ends 6, more or less parabolical in cross-section, pass over an encircling annular should 10 into the rest of the rod body 3.

The light source 2 is preferably formed by an LED, surrounded, preferably injection-molded roundabout by a light housing 4. In the housing 4, a plate (not shown) is arranged, on which electronic and/or optical components are arranged. Instead of the plate, alternatively a punched metal grid may be provided, capable of being injected roundabout with the housing in economical manner. When the plate is used, the housing is configured in two parts with a film hinge, so that it can be opened for insertion of the plate and then closed again.

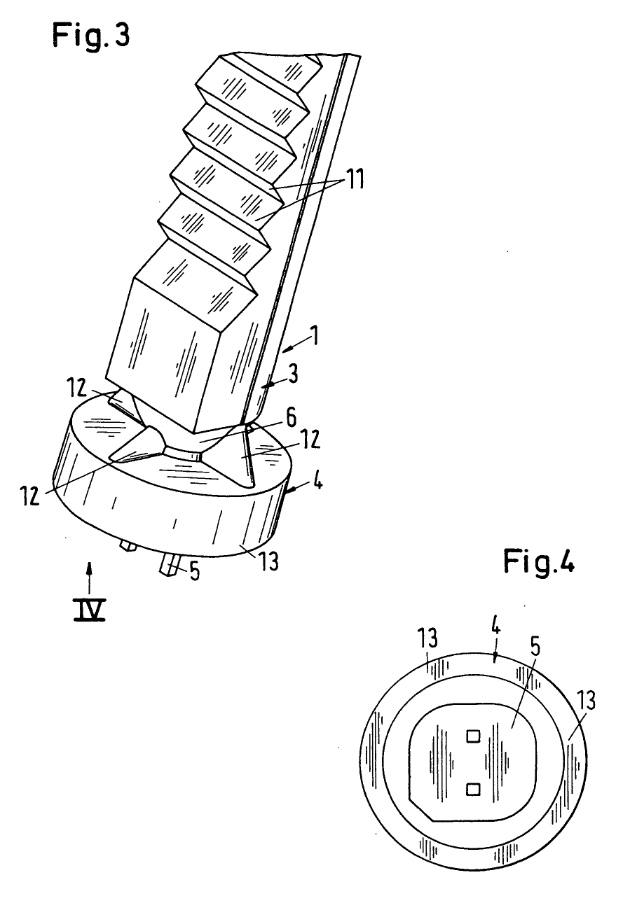

A plug 5 is integrated in the housing 4, lying perpendicular to the axis A of the light guide 3 in this embodiment by way of example. However, the plug 5 may be arranged at any other suitable angle to the axis. For example, it may alternatively run in axial direction, as in the embodiment according to FIG. 3.

The light sources 2 are so arranged in relation to the point of connection, or the tapered rod end 6 of the light guide 3, that the light emitted from them will enter the light guide insofar as possible parallel (FIG. 1). In the region of the point of connection 6, the light source 2 is connected to the light guide 3 by injection molding, casting or bonding roundabout.

To stabilize the connection between the light source 2 and the light guide 3, according to FIG. 1, a sleeve 7 is provided. It is fastened by one end 8 to the housing 4 and by its other end 9 to the annular shoulder 10 of the light guide 3. The sleeve 7 is beveled in the region of its end 9. This beveled inclined surface 17, arcuate in axial section, of the sleeve 7, lies in areal contact with the rod end 6 of the light guide 3. The sleeve 7 may be provided with lateral openings (not shown) in order not to interfere with the distribution of light from the point where the light rays are coupled into the light guide 3. Instead of the sleeve 7, alternatively webs 12 (FIG. 3) lying at a distance from each other, extending between the housing 4 and the shoulder 10, or the periphery of the rod end 6 of the light guide 3, may be provided. As FIG. 2 shows, the main direction of emission of the light rays L emitted by the light source 2 into the junction 6 of the light guide 3 at the arbitrary angle to the longitudinal axis A of the light guide 3 may be provided.

The light guide 3 may also be of any shape. It may, for example, be of polygonal or round configuration in cross-section.

On one side, the light guide 3 comprises light exit surfaces 11, formed by a saw-tooth profile 11 extending in lengthwise direction of the light conductor. The light exit surfaces 11 are plane and may extend advantageously over the width of the light guide 3. Neighboring light exit surfaces 11 adjoin each other at right angles. It is, of course, possible that the light surfaces 11 may adjoin each other at acute or obtuse angles. In the embodiment by way of example, all light exit surfaces 11 are of like configuration. Depending on application, they may alternatively be shaped differently. The light exit surfaces 11 may be provided over almost the entire length of the light guide 3. It is also possible to provide the light exit surfaces 11 only segment-wise along the light guide 3. Further, the light exit surfaces 11 may alternatively be arranged on different sides of the light guide 3.

On the side opposed to the light exit surfaces 11, the light guide 3 is provided with light deflecting means (not shown).

The embodiment according to FIGS. 3 and 4 is distinguished from the previous embodiment by way of example essentially only in that instead of the sleeve 7, the webs 12 are provided, and in that the plug 5 extends not laterally but in lengthwise direction of the light guide downward over the housing 4 of the light source 2. The webs 12 extend from close to the periphery 13 of the housing 4 as far as the rod end 6 of the light guide 3. The thickness and width of the webs 12, preferably distributed uniformly around the rod end 6, increase towards the rod end 6, preferably continuously. In this embodiment by way of example, four webs 12 are provided, arranged at angular distances of 90° from each other.

The light guide 3 is rectangular in cross-section. The side 18 opposed to the light exit surfaces 11 is of plane configuration.

In another embodiment, not shown, the webs 12 may alternatively be omitted.

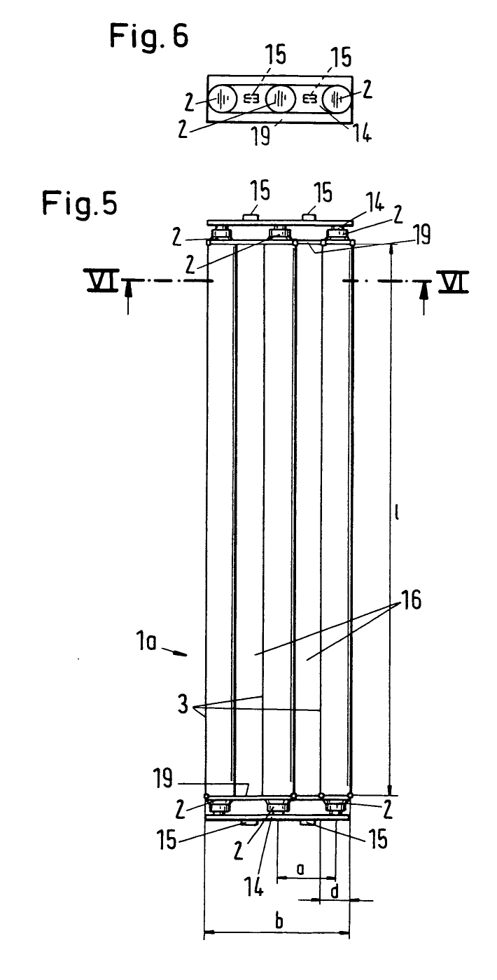

FIGS. 5 to 7 show another embodiment of a light la, comprising several, in this embodiment by way of example three light guides 3 arranged at equal distance from each other.

The light guide 3 are connected to each other endwise by way of a connecting plate 14 in each instance, comprising two contacts 15 in each instance as current junction on their sides away from the light guides 3. The plug-in contacts 15, seen in top view of the connection plate 14, lie between the light guides 3. Besides, the light guides 3 are connected to each other in a unit by a transverse plate 19 at a short distance from the light sources 2. The transverse plate 19, as FIG. 6 shows, is rectangular in outline, its lengthwise sides projecting beyond the light guide 3. On both connecting plates 14 are seated the light sources 2, advantageously LEDs as in the previous embodiments by way of example. The light guides 3 may be provided at a distance from each other. Then, in the intervals provided between the light guides 3 and the light sources 2, for example reflectors or other light elements for the motor vehicle may be provided.

The light guides 3 may alternatively be provided lying in contact with each other.

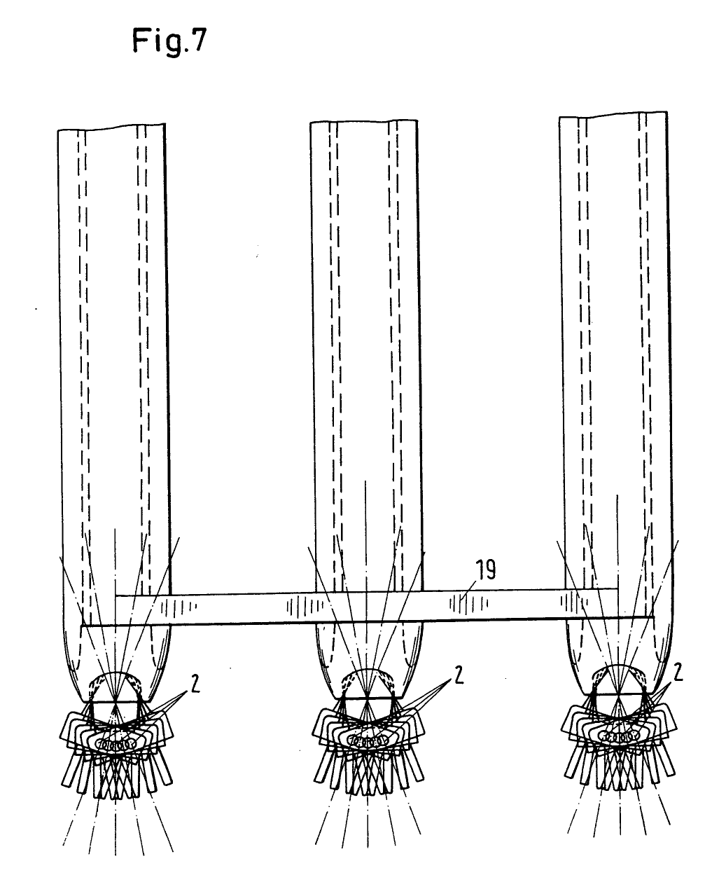

As FIG. 7 shows, the main directions of emission from the light sources 2, as in the embodiments previously described by way of example, may lie at any angle to the particular lengthwise axis of the corresponding light guide 3. Here, the directions of admission of the various light guides 3 may be different.

Alternatively, of course, only two or more than three light units 2, 3 may be combined in a light 1 a in a manner similar to FIGS. 5 to 7. The light units 2, 3 are of like configuration in the embodiment by way of example, but may alternatively be differently configured.

The light configurations described according to FIGS. 1 to 7 have the advantage that in the neighborhood of the points 6 where light is coupled in, only minor losses of light arise. The light can be transported loss-free to the exit surfaces 11, by which the light exit may be guided to well-defined areas.

Because of the low loss of light, the light sources 2 may be configured relatively small, so that the lights 1,1a occupy but little space, and can be installed in simple manner under cramped conditions. The lights 1,1a described further afford a homogeneous illumination. Since the light exit surfaces 11 are preferably formed by prisms, they may be varied at will.

The light emitted by the light sources 2, according to the intended application, may have different shapes of color.

The description of the invention is merely exemplary in nature and, thus, variations that do not depart from the gist of the invention are intended to be within the scope of the invention. Such variations are not to be regarded as a departure from the spirit and scope of the invention.

1. A light for a vehicle, in particular for motor vehicles, comprising at least one light source to which at least one light guide is connected, said light source being connected permanently to the light guide.

2. The light according to claim 1, wherein the light source is an LED.

3. The light according to claim 1, wherein the light source is connected permanently to the light guide by injection molding, casting, bonding or combinations thereof.

4. The light according to claim 1, wherein the light source is so arranged in relation to the light guide that the light emitted from it arrives substantially parallel in the light guide.

5. The light according to claim 1, where the light source is partly surrounded by a housing.

6. The light according to claim 5, further comprising a housing including at least one of a plate, a punched metal grid or combination thereof, which includes a bearing electronic component, an optical component or combination thereof.

7. The light according to claim 5, wherein the housing comprises at least one plug.

8. The light according to claim 5, wherein the housing is made in one piece.

9. The light according to claim 5, wherein the housing comprises at least one lid.

10. The light according to claim 1, further comprising the light source and the light guide in the neighborhood of a point where light is coupled in, at least one stiffening part is provided.

11. The light according to claim 10, wherein the stiffening part is a sleeve.

12. The light according to claim 10, wherein the stiffening part is formed by at least one web.

13. The light according to claim 1, wherein the light guide comprises at least one light exit surface.

14. The light according to claim 1, wherein a plurality of light guides located side by side, each having at least one light source, are provided.

15. The light according to claim 14, wherein the light guides are arranged at a distance from each other.

16. The light according to claim 14, further comprising a region between the one of the neighboring light guides and/or the light sources, additional light parts, such as reflectors and the like, are arranged.

17. The light according to claim 9, wherein said lid is swingably mounted.

18. The light according to claim 11, wherein said sleeve includes lateral openings.

19. The light according to claim 12, wherein said stiffening part includes a plurality of spaced webs.
